(19) United States
(12) Patent Application Publication
(10) Pub. No.: US 2008/0241395 A1
(43) Pub. Date: Oct. 2, 2008

(54) Ink composition and recording method using this ink composition

(75) Inventor: Hidehiko Komatsu, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/079,501

(22) Filed: Mar. 27, 2008

(30) Foreign Application Priority Data
Mar. 27, 2007 (JP) 2007-080888
Dec. 11, 2007 (JP) 2007-319272

(51) Int. Cl. B05D 5/06; C08K 9/10

(52) U.S. Cl. 427/256; 523/216

(57) ABSTRACT

An ink composition containing at least a chromatic pigment, polymer particles and water, and further containing hydrophobic silica fine particles.

This application claims priority from Japanese Patent Application No. 2007-080888, filed on Mar. 27, 2007, and from Japanese Patent Application No. 2007-319272, filed on Dec. 11, 2007, the contents of which are incorporated herein.

### BACKGROUND

1. Technical Field

The present invention relates to an ink composition and to a recording method for printing using this ink composition.

Specifically, it relates to an ink composition that provides a high printing concentration and excellent glossiness while allowing for even more stable discharge and making it possible for the phenomenon (bronzing phenomenon), in which the color of the light source as reflected from a chromatic ink is different from the color of the original light source, to be suppressed without detracting from the glossy appearance, and to a recording method for printing using this ink composition.

2. Related Art

Inkjet recording is a recording system whereby words and images are obtained by direct discharge of ink droplets from a fine nozzle onto a recording medium. This recording method has become popular for reasons of convenience because it is inexpensive and easily adaptable to full color, allows printing without contact with the recording medium so that in principle it is unaffected by the surface condition of the recording medium, and allows printing on a variety of recording media including plain paper, glossy recording paper and the like.

In recent years, those using pigments as the coloring materials have become standard for reasons of weather resistance and water resistance of the printed material.

However, it is technically difficult to reduce the particle sizes of pigments, making them unsuited to silver halide photographic tone printing on glossy recording paper. However, silver salt photographic tone printing even on glossy recording paper has become possible in recent years due to improvements in dispersion technology and additive resins.

The problem has been, however, that when pigments are used as the coloring materials they are more liable to bronzing than dye inks. This problem is particularly conspicuous in the case of printing on glossy recording paper. This occurs because the particles of the pigment used as the coloring material are exposed on the surface of the glossy recording paper, so that a new surface is formed by the pigment particles exposed on the recorded part formed by the pigment ink, resulting in a larger percentage of wavelength components in the absorption band of the pigment in the reflected light. Bronzing is a particular problem when cyan pigments are used. As a result, when forming an image using multiple colors of pigment ink, strong bronzing occurs only in the region contributed by the cyan pigment ink, giving a very unpleasant impression.

An effective means of reducing this bronzing phenomenon is to add inorganic particles having a higher refractive index than the pigment particles to the ink, and various proposals of this sort have been made.

For example, JP-A6-287492 discloses an ink containing surface hydrophilicity-treated titanium dioxide and carbon black as an example using a pigment as the coloring material together with a titanium dioxide pigment in the ink composition.

JP-A-2006-336001 discloses an ink composition containing titanium dioxide fine particles as a means for reducing the bronzing phenomenon that occurs when an image is formed using a cyan pigment ink.

Furthermore, JP-A-2002-206063 discloses an inkjet ink containing a pigment and hydrophilic colloidal silica.

Conventional ink compositions containing titanium dioxide are quite effective at reducing bronzing. However, when titanium particles with a high relative density are added to an aqueous ink composition they precipitate, creating a serious problem of concentration distribution of solid components in the ink, and making long-term storage difficult.

When hydrophilic silica particles are added to an ink, on the other hand, the problem of precipitation can be avoided by using fine particles of silica with a relatively low relative density. In this case, however, there are problems of discharge from the inkjet head. This occurs because the hydrophilic silica particles dissolve relatively easily in the aqueous ink. In other words, because the silica is dissolved in the aqueous components of the ink, it is eluted near the nozzle of the inkjet head and adheres, causing frequent discharge problems. Moreover, addition of hydrophilic silica particles does not suppress bronzing as effectively as addition of titanium dioxide.

### SUMMARY

Consequently, an advantage of some aspects of the invention is to provide an ink composition with excellent storage stability and discharge stability that provides a high printing concentration and excellent glossiness while suppressing bronzing without sacrificing glossy appearance, along with a recording method for printing using this ink composition.

To solve the aforementioned problems, an aspect of the present invention provides an ink composition containing at least chromatic pigment particles, polymer particles and water, and also containing hydrophobic silica fine particles. By means of such features it is possible to obtain an ink composition having excellent storage stability and stable inkjet discharge that provides a high printing concentration on plain paper and excellent glossiness on glossy specialty paper while controlling bronzing.

That is, by using hydrophobic silica it is possible to prevent dissolution of the silica in the liquid components of the ink and consequent clogging of the inkjet head, while at the same time controlling bronzing of the pigment ink. By containing the silica in polymer particles, it is also possible to achieve a stable dispersion of hydrophobic silica particles, which are otherwise difficult to disperse stably in aqueous ink, without dissolving them in the liquid components of the ink. Moreover, because the chromatic pigment and silica fine particles are contained in polymer particles, the pigment and silica fine particles are close to one another in the ink, and bronzing of the chromatic pigment is more effectively controlled by means of the hydrophobic silica fine particles.

Preferred embodiments of this invention are as follows. The weight ratio of the hydrophobic silica fine particles to the chromatic pigment is preferably between 1:20 and 2:1.

The primary particle size of the hydrophobic silica is preferably 20 nm or less.

It is also desirable that the chromatic pigment and hydrophobic silica fine particles be contained in the polymer particles, and that the polymer particles be water-insoluble polymer particles.

That is, using water-insoluble polymer particles has the effect of making it easier to contain the chromatic pigment and hydrophobic silica fine particles in the polymer particles, and also makes it easier to obtain a high printing concentration on plain paper.

The content of dissolved silica in the liquid components of the ink is preferably 50 ppm or less.

It is also desirable to include a penetration enhancer and/or humectant.

The present invention also provides a recording method for printing on a recording medium by affixing an ink composition, wherein the aforementioned ink composition is used as the ink composition.

The present invention also provides an inkjet recording method for printing by discharging droplets of ink composition and affixing those droplets to a recording medium, wherein the aforementioned ink composition is used as the ink composition.

The present invention provides an ink composition whereby strong color development on plain paper and high gloss on glossy recording paper are provided while bronzing is controlled and stable discharge properties and storage stability are ensured by means of an ink composition containing at least chromatic pigment particles, polymer particles and hydrophobic silica fine particles, and also provides a recording method using this ink.

### DESCRIPTION OF EXEMPLARY EMBODIMENTS

Ink Composition

An ink composition of an embodiment of the invention is explained here in more detail. As discussed above, the ink composition of this embodiment contains hydrophobic silica fine particles in an ink composition containing at least a chromatic pigment, polymer particles and water.

The hydrophobic silica fine particles used in this embodiment can be those that have been commonly used in the past, and are preferably those that have been surface treated, such as for example those that have been surface treated with dimethyldichlorosilane, methacryloxysilane, dimethyl polysiloxane, octamethylcyclotetrasiloxane or the like.

The primary particle diameter of the hydrophobic silica fine particles is preferably 1 μm or less or more preferably 100 nm or less or still more preferably 50 nm or less or ideally 20 nm or less for purposes of achieving glossiness of the printed matter and suppressing bronzing.

In this description, the “primary particle diameter” is the size of a particle formed by aggregation of single crystals or crystallites similar to single crystals. The primary particle diameter of a particle is measured by electron microscopy. The size of a pigment particle is measured from an electron microscope image by dispersing the pigment in an organic solvent, fixing it on a support film, and taking a scanning electron microscope image which is then image processed and measured to obtain a more reliable value. Specifically, the short axial and long axial lengths of individual primary particles are measured, the diameter of a circle of equivalent area is calculated and given as the primary particle diameter, and the average is taken for 50 or more pigment particles selected at random from a given visual field. Another measurement method that provides the same degree of reliability could also be used, but if there is a discrepancy in the results the values obtained by the aforementioned method are adopted.

The amount of dissolved silica in the liquid components of the ink is preferably 100 ppm or less or more preferably 50 ppm or less or still more preferably 25 ppm or less.

For example, when hydrophilic silica particles are used the silica is likely to be present in a dissolved state in the liquid components of the ink, and this dissolved silica tends to be eluted and adhere near the nozzle of the inkjet head, causing frequent discharge problems.

The added amount of the hydrophobic silica fine particles is determined appropriately based mainly on the added amount of the chromatic pigment, but from the standpoint of glossiness of the printed matter and bronzing prevention, it is preferably at least 0.01 wt %, or more preferably at least 0.1 wt %, or still more preferably 0.1 to 5 wt % as solids based on 100 wt % as the weight of the ink composition.

The hydrophobic silica fine particles used in this embodiment may be those that are conventionally used, but from the standpoint of glossiness of the printed matter and bronzing prevention as well ink manufacture, colloidal silica, fumed silica or the like is preferred. In particular, because fumed silica consists of silica (SiO2) fine particles obtained by baking silicon tetrachloride in an oxyhydrogen flame, the particle size is easy to control by means of the baking conditions, making it easier to control the particle size of the dispersion in the ink. Specific examples of such silica fine particles include:
Microid ML-367W, Microid ML-369W, Microid ML-386W (Tokai Chemical Industries Co., Ltd.),

Aerosil R972, Aerosil R974, Aerosil R805, Aerosil R7200, Aerosil R711, Aerosil R202, Aerosil R104, Aerosil R106 (Evonik Degussa Japan),
SP Seal H, Sp Seal S (Kaleido Co., Ltd)
Organosilica gel IPA-ST, Organosilica gel IPA-ST-U P, Organosilica gel IPA-ST-ZL, Organosilica gel NPC-ST-30, Organosilica gel MEK-ST, Organosilica gel PMA-ST, Organosilica gel PGM-ST (Nissan Chemical Industries, Ltd.)
   and the like.

The pH of these commercial silica fine particles is adjusted to acidic or alkaline, and is selected according to the pH of the ink composition to which the particles are to be added.

The content of the hydrophobic silica fine particles is adjusted appropriately according to the added amount of the chromatic pigment, but is preferably at least 0.01 wt %, or more preferably at least 0.1 wt %, or still more preferably 0.1 to 5 wt % as solids based on 100 wt % as the weight of the ink composition. The primary particle diameter of the hydrophobic silica fine particles is preferably 1 μm or less or more preferably 100 nm or less or still more preferably 50 nm or less or ideally 20 nm or less for purposes of achieving storage stability (precipitation properties) of the ink composition and glossiness of the printed matter while controlling bronzing.

The chromatic pigment used in the present invention may be a cyan pigment, yellow pigment, magenta pigment or the like for example. “Chromatic” here includes all colors other than the sequence ranging from white through gray to black (achromatic colors).

Examples of cyan pigments include C.I. pigment blue 1, 2, 15, 15:1, 15:2, 15:3, 15:4 and 16 and C. I. vat blue 4 and 60 and the like. These cyan pigments may be used alone, or a mixture of 2 or more may be used.

Examples of yellow pigments include C. I. pigment yellow 1, 3, 12, 13, 14, 17, 24, 35, 37, 42, 53, 55, 74, 81, 83, 95, 97, 98, 100, 101, 104, 108, 109, 110, 117, 120, 128, 138, 147, 150, 153, 155, 174, 180, 188, 198 and the like. These yellow pigments may be used alone, or a mixture of 2 or more may be used.

Examples of magenta pigments include C. I. pigment red 1, 3, 5, 8, 9, 16, 17, 19, 22, 38, 57:1, 90, 112, 122, 123, 127, 146, 184, 202, 207 and 209 and C. I. pigment violet 1, 3, 5:1, 16, 19, 23, 38 and the like. These magenta pigments may be used alone, or a mixture of 2 or more may be used.

Of these chromatic pigments, the cyan pigments are desirable because the bronzing prevention effect is greater. Of the cyan pigments, it is desirable for the same reason to use 1 or more selected from C. I. pigment blue 15, 15:1, 15:2, 15:3, 15:4 and 16.

A pigment not listed in the color index may also be used as long as it is insoluble in water.

The compounded amount of the chromatic pigment used in an ink composition of this embodiment is preferably 0.1 wt % to 15 wt % or more preferably 0.5 wt % to 8 wt % from the standpoint of color development and recovery from clogging. Considering also the added amount of the hydrophobic silica fine particles, the weight ratio of hydrophobic silica fine particles to chromatic pigment is preferably 1:20 to 2:1 or more preferably 1:10 to 1:1 or still more preferably 1:8 to 1:2 from the standpoint of glossiness of the printed matter and bronzing prevention.

The ink composition of this embodiment contains polymer particles. A water-insoluble polymer is preferred for the polymer particles because the chromatic pigment and hydrophobic silica fine particles are more easily contained therein.

Examples of water-insoluble polymers include water-insoluble vinyl polymers, water-insoluble ester polymers, water-insoluble urethane polymers and the like. Of these, water-insoluble vinyl polymer particles obtained by addition polymerization of a vinyl monomer (vinyl compound, vinylidene compound, vinylene compound) are particularly desirable.

The water-insoluble polymer used for the water-insoluble polymer particles is preferably a water-insoluble polymer obtained by copolymerization of a monomer mixture containing a salt-producing group-containing monomer, a macromer and/or a hydrophobic monomer.

The salt-producing group-containing monomer is used in order to increase the dispersion stability of the resulting dispersion. Examples of salt-producing groups include carboxy, sulfonic acid, phosphoric acid, amino and ammonium groups and the like.

A salt-producing group-containing monomer may be a cationic monomer, anionic monomer or the like, and examples include unsaturated amine-containing monomers, unsaturated ammonium salt-containing monomers and the like.

Typical examples of anionic monomers include unsaturated carboxylic acid monomers, unsaturated sulfonic acid monomers, unsaturated phosphoric acid monomers and the like.

Examples of unsaturated carboxylic acid monomers include acrylic acid, methacrylic acid, crotonic acid, itaconic acid, maleic acid, fumaric acid, citraconic acid, 2-methacryloyloxy methylsuccinic acid and the like. Examples of unsaturated sulfonic acid monomers include styrenesulfonic acid, 2-acrylamido-2-methylpropanesulfonic acid, 3-sulfopropyl (meth)acrylate, bis-3-sulfopropyl-itaconic acid ester and the like. Examples of unsaturated phosphoric acid monomers include vinylphosphonic acid, vinyl phosphate, bis(methacryloxyethyl) phosphate, diphenyl-2-acryloyloxy ethylphosphate, diphenyl-2-methacryloyloxy ethylphosphate, dibutyl-2-acryloyloxy ethylphosphate and the like.

The macromer is used in order to increase dispersion stability of the polymer particles when the particle contain a pigment in particular. Examples of macromers include monomers with a number-average molecular weight of 500 to 100,000 or preferably 1,000 to 10,000 that contain polymerizable unsaturated groups. Of the macromers, aromatic group-containing (meth)acrylate macromers and styrene macromers having polymerizable functional groups at one end are preferred from the standpoint of dispersion stability of the polymer particles.

Examples of styrene macromers include single polymers of styrene monomers and copolymers of styrene monomers with other monomers. Examples of styrene monomers include styrene, 2-methylstyrene, vinyl toluene, ethyl vinyl benzene, vinyl naphthalene, chlorostyrene and the like.

Examples of aromatic group-containing (meth)acrylate macromers include single polymers of aromatic group-containing (meth)acrylates and copolymers of these with other monomers.

The hydrophobic monomer is used to improve printing concentration, glossiness and image clarity. Examples of hydrophobic monomers include alkyl (meth)acrylates, aromatic group-containing monomers and the like.

An alkyl (meth)acrylate is preferably one having a C₁₋₂₂ or preferably C₅₋₁₈ alkyl group, and examples include methyl (meth)acrylate, ethyl (meth)acrylate, (iso)propyl (meth)acrylate, (iso or tertiary) butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate, (iso)stearyl (meth)acrylate and the like.

An aromatic group-containing monomer is preferably a vinyl monomer having a C₆₋₂₂ or preferably C₆₋₁₂ aromatic group and optionally having a substituent containing a hetero atom, and examples include the aforementioned styrene monomers and aromatic group-containing (meth)acrylates. Examples of substituents containing hetero atoms included those given above.

The monomer mixture may also contain a nonionic (meth)acrylate monomer, typical examples of which include polyethylene glycol mono(meth)acrylate, polypropylene glycol mono(meth)acrylate, ethylene glycol-propylene glycol (meth)acrylate and the like.

The ink composition of this embodiment contains water as the principal solvent. Ion-exchange water, ultrafiltered water, reverse osmosis water, distilled water or other pure or ultrapure water is preferably used as the water. It is particularly desirable to use such water that has been sterilized by ultraviolet exposure or addition of hydrogen peroxide or the like in order to prevent contamination by mold or bacteria long-term.

A penetration enhancer is preferably added to the ink composition of this embodiment in order to increase wettability of the recording medium and penetration of the organic pigment. A 1,2-alkanediol and/or glycol ether is preferably included as the penetration enhancer. Specific examples of 1,2-alkanediols include 1,2-octanediol, 1,2-hexanediol, 1,2-pentanediol, 4-methyl-1,2-pentanediol and the like. Specific examples of glycol ethers include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether and the like. 1 or 2 or more of these solvents may be used, and they are included in the composition in the amount of preferably between 2 wt % and 15 wt % in order to ensure suitable penetration and drying properties. Of these penetration enhancers, a 1,2-alkanediol is particularly desirable as an additive in the ink composition of the present invention. When included in the ink composition of the invention of this application, hydrophobic silica fine particles and 1,2-alkanediol act synergistically to help reduce bronzing and improve glossiness. In such cases, the inventors have found that such effects are obtained by adding 1,2-hexanediol to the ink in the amount of 1 wt % to 10 wt % or preferably 2 wt % to 8 wt %.

Other desirable examples of penetration enhancers include surface tension adjusters. A surface tension adjuster is preferably an acetylene glycol surfactant or polyether-denatured siloxane. Examples of acetylene glycol surfactants include Surfinol 420, 440, 465, 485 and 104 and STG (Air Products Co.), Olfine PD-001, SPC, E1004 and E1010 (Nisshin Chemical Industry Co., Ltd.), Acetylenol E00, E40, E100 and LH (Kawaken Fine Chemicals Co., Ltd.) and the like. Examples of polyether-denatured siloxanes include BYK-346, 347 and 348 and UV3530 (Byk Chemie) and the like. 1 or 2 or more of these can be used in the ink composition, and the surface tension is preferably adjusted to 20 mN/m to 40 mN/m by including 0.1% to 3.0 wt % thereof in the ink composition.

It is also desirable to add a humectant to the ink composition of this embodiment in order to prevent the ink composition from drying and clogging the head of the inkjet printer. Examples of humectants include glycerin, 1,2,6-hexanetriol, trimethylolethane, trimethylolpropane, ethylene glycol, propylene glycol, diethylene glycol, triethylene glycol, tetraethylene glycol, pentaethylene glycol, dipropylene glycol, 2-buten-1,4-diol, 2-ethyl-1,3-hexanediol, 2-methyl-2,4-pentanediol and other polyvalent alcohols, glucose, mannose, fructose, ribose, xylose, arabinose, galactose, aldonic acid, glucitol (sorbitol), maltose, cellobiose, lactose, sucrose, trehalose, maltotriose and other sugars, sugar alcohols, hyaluronic acids, 1,2-dimethylurea, ureas, ethanol, methanol, butanol, propanol, isopropanol and other C₁₋₄ alkyl alcohols, and 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, sulfolane and the like. 1 or 2 or more of these can be used in the ink composition, preferably in the amount of 10 wt % to 50 wt % of the ink composition in order to ensure appropriate values for material properties (viscosity and the like) of the ink composition, as well as printing quality, reliability and the like.

Materials selected from the pH adjusters, preservatives, mold-proofing agents, rustproofing agents, solubilizers, antioxidants and the like can also be added as desired to the ink composition of this embodiment. 1 or a mixture of 2 or more of each kind of component may be added. They do not have to be added if there is no need to do so. A person skilled in the art can select desirable additives in desired amounts to the extent that they do not detract from the effects of the present invention.

A hydroxide of an alkali earth metal such as lithium hydroxide, potassium hydroxide or sodium hydroxide, or an amine such as ammonia, triethanolamine, tripropanolamine, diethanolamine or monoethanolamine or the like can be used as a pH adjuster, but preferably at least 1 pH adjuster selected from the hydroxides of alkali earth metals and ammonia, triethanolamine and tripropanolamine is included, and the pH is preferably adjusted to 6 to 10. If the pH is outside this range, the materials making up the inkjet printer may be adversely affected, and clogging recovery may decline.

Examples of preservatives and mold-proofing agents include sodium benzoate, sodium pentachlorophenol, sodium 2-pyridinethiol-1-oxide, sodium sorbate, sodium dehydroacetate and 1,2-dibenzisothiazoline-3-one (AVECIA Co. trade names Proxel CRL, Proxel BDN, Proxel GXL, Proxel XL-2 and Proxel TN) and the like, but are not limited to these.

Solubilizers are additives for dissolving insoluble matter that precipitates from the ink composition and maintaining the ink composition as a uniform solution. Examples of solubilizers include N-methyl-2-pyrrolidone, 2-pyrrolidone and other pyrrolidones, urea, thiourea, tetramethyl urea and other ureas, allophanate, methyl allophanate and other allophanates, and biuret, dimethyl biuret, tetramethyl biuret and other biurets and the like, but are not limited to these.

Examples of antioxidants include L-ascorbic acid and salts thereof, but are not limited to these.

Recording Method

The recording method of this embodiment is a method of recording using the ink composition described above. Methods of recording using ink compositions include for example inkjet recording methods, recording methods using pens and other writing instruments, and various printing methods and the like. Consequently, the ink composition of this embodiment can be used favorably for applications including pens and other writing implements, inkjet recording methods, printing, stamping and the like.

Another aspect of the recording method of this embodiment provides an inkjet recording method whereby printing is accomplished by discharging droplets of the ink composition of the aforementioned embodiment and affixing them to a recording medium. Any method whereby the aforementioned ink composition is discharged as droplets from a fine nozzle and these droplets are affixed to a recording medium can be used as the inkjet recording method of this embodiment. Various kinds of methods are known as specific examples of such methods.

One example of such a method is an electrostatic attraction system. In this system, a strong electrical field is applied between a nozzle and an accelerating electrode located in front of the nozzle, so that an ink composition is sprayed continuously as liquid droplets from the nozzle, and recording is accomplished by means of a printing data signal applied to deflecting electrodes as the ink droplets pass between the deflecting electrodes. If necessary, the ink droplets may also be sprayed in response to the printing data signal without being deflected in this method.

In another aspect, pressure is applied to ink droplets by means of a small pump, and the nozzle is mechanically oscillated by means of a crystal oscillator or the like to thereby forcibly spray ink droplets. In this method, the ink droplets are charged as they are sprayed, and recording is accomplished by means of a printing data signal applied to deflecting electrodes as the ink droplets pass between the deflecting electrodes. Another aspect is a method using a piezoelectric element. In this method, printing is accomplished by simultaneously applying a printing data signal and pressure to an ink by means of a piezoelectric element to thereby spray ink droplets. Another aspect is a method involving rapid volume expansion of ink by application of thermal energy. In this method, the ink is heated and foamed by a microelectrode in response to a printing data signal to thereby spray ink droplets and accomplish printing.

The recording medium is not particularly limited, and for example plain paper, specialty inkjet paper (glossy or matte), plastic, film, metal and various other recording media can be used.

In the following manufacturing examples, examples and comparative examples, “parts” and “%” indicate “parts by weight” and “wt %” unless otherwise specified.

### EXAMPLE 1

(1) Manufacture of Aqueous Dispersion Containing Chromatic Pigment and Silica Fine Particles in Polymer Particles

10 wt % each of 25 parts by weight of methyl ethyl ketone, 0.04 parts by weight of a polymer chain transfer agent (2-mercaptoethanol), 15 parts by weight of methacrylic acid (Mitsubishi Gas Chemical Co., Inc., trade name GE-110 (MAA)), 15 parts by weight of styrene macromer (Toagosei Co., Ltd., trade name AS-6S), 30 parts by weight of 2-ethylhexyl methacrylate (Mitsubishi Rayon Co., Ltd., trade name Acryester EH), 25 parts by weight of styrene monomer (Nippon Steel, trade name Styrene Monomer) and 15 parts by weight of methoxypolyethylene glycol monomethacrylate were added and mixed in a reaction container, and thorough nitrogen gas substitution was performed to obtain a mixed solution.

The remaining 90 wt % of each of the aforementioned monomers was added to a drip funnel, 0.27 parts by weight of a polymer chain transfer agent (2-mercaptoethanol), 60 parts by weight of methyl ethyl ketone and 1.2 parts by weight of 2,2′-azobis(2,4-dimethylvaleronitrile) were added and mixed, and thorough nitrogen gas substitution was performed to obtain a mixed solution.

The mixed solution in the reaction container was heated to 75° C. with agitation in a nitrogen atmosphere, and the mixed solution in the drip funnel was then gradually dripped into the reaction container over the course of 3 hours. After completion of dripping, the temperature of the mixed solution was maintained at 75° C. for 2 hours, and a solution of 0.3 parts by weight of 2,2′-azobis(2,4-dimethylvaleronitrile) dissolved in 5 parts by weight of methyl ethyl ketone was added to the mixed solution and cured for 2 hours at 75° C. and 2 hours at 85° C. to obtain a polymer solution.

Part of the resulting polymer solution was dried for 2 hours at 105° C. under reduced pressure to remove the solvent and isolate the polymer. According to gel permeation chromatography using polystyrene as the standard substance and dimethylformamide containing 60 mmol/L phosphoric acid and 50 mmol/L lithium bromide as the solvent, the weight-average molecular weight was 121,000.

30 parts by weight of copolymer obtained by drying the resulting copolymer solution under reduced pressure was dissolved in 75 parts by weight of methyl ethyl ketone, 220 parts by weight of ion-exchange water and a specific amount (enough to neutralize 65% of salt-producing groups) of sodium hydroxide (30% aqueous solution) were added to neutralize part of the copolymer, and 60 parts by weight of C. I. pigment blue 15:4 as the chromatic pigment and 10 parts by weight of Aerosil R106 hydrophobic silica fine particles (primary particle size 7 nm, Evonik Degussa Japan) were added and kneaded in a bead mill to obtain a primary dispersion.

255 parts by weight of ion-exchange water was added to the resulting kneaded product and agitated, the organic solvent was removed under reduced pressure at 60° C., and part of the water was then removed to obtain an aqueous dispersion of polymer particles containing a chromatic pigment and hydrophobic silica particles, with a solids concentration of 20 wt %. The average particle diameter of the resulting aqueous dispersion was 75 nm as measured with an Otsuka Electronics ELS-800 laser particle analysis system.

(2) Manufacture of Ink Composition

35 parts by weight of the aqueous dispersion (solids concentration 20 wt %) of polymer particles containing a chromatic pigment and hydrophobic silica fine particles that was obtained in Example 1(1) were mixed with 4 parts by weight of triethylene glycol monobutyl ether, 2 parts by weight of 1,2-hexanediol, 1 part by weight of Olfine E1010 (Nisshin Chemical Industry Co., Ltd.), 15 parts by weight of glycerin, 3 parts by weight of trimethylol propane and 40 parts by weight of ion-exchange water.

The resulting mixture was filtered with a 10 μm membrane filter to obtain the ink composition of Example 1.

### EXAMPLE 2

(1) Manufacture of Aqueous Dispersion Containing Chromatic Pigment and Silica Fine Particles in Polymer Particles

An aqueous dispersion of polymer particles containing a chromatic pigment and hydrophobic silica fine particles, with a solids concentration of 20 wt %, was obtained by methods similar to those of Example 1(1) except that 66.5 parts of C. I. pigment blue 15:4 were used for the chromatic pigment and 3.5 parts of Aerosil R202 (primary particle diameter 14 nm, Evonik Degussa Japan) were used for the silica fine particles. The average particle diameter of the resulting aqueous dispersion was 85 nm as measured with an Otsuka Electronics ELS-800 laser particle analysis system.

(2) Manufacture of Ink Composition

The ink of Example 2 was obtained with a similar composition and by methods similar to those of Example 1(2), but using the aqueous dispersion (solids concentration 20 wt %) of polymer particles containing a chromatic pigment and hydrophobic silica fine particles that was obtained in Example 2(1).

### EXAMPLE 3

(1) Manufacture of Aqueous Dispersion Containing Chromatic Pigment and Silica Fine Particles in Polymer Particles

An aqueous dispersion of polymer particles containing a chromatic pigment and hydrophobic silica fine particles, with a solids concentration of 20 wt %, was obtained by methods similar to those of Example 1(1) except that 25 parts of C. I. pigment blue 15:3 were used for the chromatic pigment and 45 parts (as solids) of Organosol PMA-ST (primary particle diameter 10 nm to 20 nm, Nissan Chemical Industries, Ltd.) were used for the silica fine particles. The average particle diameter of the resulting aqueous dispersion was 98 nm as measured with an Otsuka Electronics ELS-800 laser particle analysis system.

(2) Manufacture of Ink Composition

The ink of Example 3 was obtained with a similar composition and by methods similar to those of Example 1(2), but using the aqueous dispersion (solids concentration 20 wt %) of polymer particles containing a chromatic pigment and hydrophobic silica fine particles that was obtained in Example 3(1).

### EXAMPLE 4

(1) Manufacture of Aqueous Dispersion Containing Chromatic Pigment, Silica Fine Particles and Polymer Particles

An aqueous dispersion of polymer particles containing a chromatic pigment and hydrophobic silica fine particles, with a solids concentration of 20 wt %, was obtained by methods similar to those of Example 1(1) except that 25 parts of C. I. pigment blue 15:3 were used for the chromatic pigment and 45 parts (as solids) of Organosol IPA-ST-UP (primary particle diameter 40 nm to 100 nm, Nissan Chemical Industries, Ltd.) were used for the silica fine particles. The average particle diameter of the resulting aqueous dispersion was 138 nm as measured with an Otsuka Electronics ELS-800 laser particle analysis system.

(2) Manufacture of Ink Composition

The ink of Example 4 was obtained with a composition and by methods similar to those of Example 1(2), but using the aqueous dispersion (solids concentration 20 wt %) of polymer particles containing a chromatic pigment and hydrophobic silica fine particles that was obtained in Example 4(1). COMPARATIVE EXAMPLE 1

Hydrophilic silica fine particles were used instead of hydrophobic silica fine particles in Comparative Example 1.

Because it is difficult to contain hydrophilic silica fine particles in polymer particles together with a chromatic pigment, colloidal silica was simply added to the ink composition.

(1) Manufacture of Aqueous Dispersion of Polymer Particles Containing Chromatic Pigment

In Comparative Example 1, an aqueous dispersion of polymer particles containing a chromatic pigment was prepared by methods similar to those of Example 1(1) except that only 70 parts by weight of C. I. pigment blue 15:4 was contained in the polymer particles rather than a chromatic pigment and silica fine particles. The average particle diameter of the resulting aqueous dispersion was 92 nm as measured with an Otsuka Electronics ELS-800 laser particle analysis.

(2) Manufacture of Ink Composition

30 parts by weight of the aqueous dispersion (solids concentration 20 wt %) of polymer particles containing a chromatic pigment that was obtained in Comparative Example 1(1) was mixed with 1 part (as solids) of Snowtex 20 (primary particle diameter 10 nm to 20 nm, Nissan Chemical Industries, Ltd.) as the hydrophilic colloidal silica fine particles, 4 parts by weight of triethylene glycol monobutyl ether, 2 parts by weight of 1,2-hexanediol, 1 part by weight of Olfine E1010 (Nisshin Chemical Industry Co., Ltd.), 15 parts by weight of glycerin, 3 parts by weight of trimethylol propane and 44 parts by weight of ion-exchange water.

The resulting mixture was filtered with a 10 μm membrane filter to obtain the ink composition of Comparative Example 1.

### COMPARATIVE EXAMPLE 2

The ink composition of Comparative Example 2 is an ink composition containing no hydrophobic silica fine particles or hydrophilic silica fine particles whatsoever.

(1) Manufacture of Aqueous Dispersion of Polymer Particles Containing Chromatic Pigment

The same aqueous dispersion of polymer particles containing a chromatic pigment as in Comparative Example 1(1) was used in Comparative Example 2.

(2) Manufacture of Ink Composition

30 parts by weight of the aqueous dispersion (solids concentration 20 wt %) of polymer particles containing a chromatic pigment that was obtained in Comparative Example 1(1) was mixed with 4 parts by weight of triethylene glycol monobutyl ether, 2 parts by weight of 1,2-hexanediol, 1 part by weight of Olfine E1010 (Nisshin Chemical Industry Co., Ltd.), 15 parts by weight of glycerin, 3 parts by weight of trimethylol propane and 45 parts by weight of ion-exchange water.

The resulting mixture was filtered with a 10 μm membrane filter to obtain the ink composition of Comparative Example 1.

The inks of the examples and comparative examples were then evaluated comparatively in the following tests.

### TEST EXAMPLE 1

### Evaluation of Bronzing

The following bronzing evaluation was performed using the ink compositions of Examples 1 to 4 and Comparative Examples 1 and 2. Patch patterns with a printing duty of 100% and 40% were printed at a resolution of 1440×720 dpi on Kotakugata no Senyoshi (glossy type exclusive paper) of photographic paper (Seiko Epson) with a PX-A650 inkjet printer (Seiko Epson), and left for 24 hours at 25° C., after which changes in the color of reflected light were observed with the naked eye at different angles under a fluorescent lamp (F11 light source), and bronzing was evaluated by the following criteria. The results are shown in Table 1.

A: Reflected light appears white in both 100% and 40% duty patch patterns, no unpleasant appearance

B: Reflected light appears white in either 100% or 40% duty patch pattern, no unpleasant appearance

C: Color appears in reflected light from both 100% and 40% duty patch patterns, unpleasant appearance

### TEST EXAMPLE 2

### Evaluation of Glossiness

The 450 specular gloss of the 100% duty printed matter used in Test Example 1 was measured with a GP-200 Goniophotometer (Murakami Color Research Laboratory), and glossiness was evaluated according to the following criteria. The results are shown in Table 1.

| | |
|---|---|
| A: | 45° specular gloss 30 or more |
| B: | 45° specular gloss 25 to less than 30 |
| C: | 45° specular gloss less than 25 |

### TEST EXAMPLE 3

### Evaluation of Color Development on Plain Paper

Color development on plain paper was evaluated as follows using the ink compositions of Examples 1 to 4 and Comparative Examples 1 and 2. Solid patterns with a printing duty of 100% were printed at a resolution of 720×720 dpi on Xerox-4200 paper using the inkjet printer used in Test Example 1, and left for 24 hours at 25° C., after which the OD value of the printed matter was measured with a Spectrolino (Gretag), and evaluated by the following criteria. The results are shown in Table 1.

| | |
|---|---|
| A: | OD over 1.1 |
| B: | OD 1.0 to 1.1 |
| C: | OD less than 1.0 |

### TEST EXAMPLE 4

### Evaluation of Discharge Stability

Discharge stability was evaluated as follows using the ink compositions of Examples 1 to 4 and Comparative Examples 1 and 2. Using the same inkjet printer as in Test Example 1, inkjet cartridges were filled with each of the ink compositions and mounted on the inkjet printer, and once normal discharge from all nozzles was confirmed, patch patterns were continuously printed on “Glossy” photographic paper at 40° C. under the same conditions as for Evaluation 1. The presence or absence of dot skipping during printing and scattering of the ink composition was observed for each ink composition, and discharge stability was evaluated based on the following criteria. The results are shown in Table 1.

| | |
|---|---|
| A: | No dot skipping or scattering of the ink composition even after |
| | 4 hours |
| B: | Some dot skipping or scattering of the ink composition after 3 hours |
| C: | Some dot skipping or scattering of the ink composition after 2 hours |

### TEST EXAMPLE 5

### Evaluation of Clogging Recoverability

Clogging recoverability was evaluated as follows using the ink compositions of Examples 1 to 4 and Comparative Examples 1 and 2. Using the same inkjet printer as in Test Example 1, inkjet cartridges were filled with each of the ink compositions and mounted on the inkjet printer, and once normal discharge from all nozzles was confirmed, the inkjet printer was stopped, the cartridges were removed from the inkjet printer, and the printer head was left for 1 week uncapped in a 40° C. environment. Ink cartridges filled with the same ink compositions were then mounted, the number of cleanings required to achieve discharge of the ink composition from all nozzles was counted, and clogging recoverability was evaluated based on the following criteria. The results are shown in Table 1.

| | |
|---|---|
| A: | All nozzles restored by 2 or fewer cleanings |
| B: | All nozzles restored by 3 to 5 cleanings |
| C: | All nozzles not restored by 6 cleanings |

### TEST EXAMPLE 6

### Evaluation of Storage Stability

Storage stability was evaluated as follows using the ink compositions of Examples 1 to 4 and Comparative Examples 1 and 2. 50 g of each ink composition was stored for 2 weeks in a 60° C. environment in an aluminum package. The presence or absence of extraneous matter (floating matter or precipitate) after storage was observed with the naked eye, and when there was no extraneous matter changes in physical properties (viscosity, surface tension, pH, particle diameter) were investigated, and storage stability was evaluated based on the following criteria. The results are shown in Table 1.

| | |
|---|---|
| A: | No extraneous matter, no change in physical properties |
| B: | No extraneous matter, but some change in physical properties |
| C: | Extraneous matter or substantial change in physical properties |

### TEST EXAMPLE 7

### Evaluation of Dissolved Silica

The necessary amounts of the ink compositions of Examples 1 to 4 and Comparative Examples 1 and 2 were taken and centrifuged with a centrifugal ultrafiltration unit (C-15, Millipore Corporation). A Type NMWL 10000 filter was used, under centrifugation conditions of 2500 G×60 minutes. The Si in the resulting filtrate was measured by ICP emission spectrometry (ICPS-8000, Shimadzu), and the amount of dissolved silica in the liquid components of the ink was assayed. The results are shown in Table 1.

TABLE 1

| | | | | | Comparative | Comparative |
|---|---|---|---|---|---|---|
| | Example 1 | Example 2 | Example 3 | Example 4 | Example 1 | Example 2 |
| Evaluation of | A | B | A | A | B | C |
| Bronzing | | | | | | |
| Evaluation of | A | A | A | B | B | B |
| glossiness | | | | | | |
| Evaluation of color | A | A | B | B | A | A |
| development on | | | | | | |
| plain paper | | | | | | |
| Evaluation of | A | A | A | B | C | B |
| discharge stability | | | | | | |
| Evaluation of | A | A | A | B | C | A |
| clogging | | | | | | |
| recoverability | | | | | | |
| Evaluation of | A | A | A | B | C | A |
| storage stability | | | | | | |
| Evaluation of | 20 ppm | 15 ppm | 45 ppm | 56 ppm | 120 ppm | Below the |
| dissolved silica | | | | | | minimum |
| | | | | | | measurable |
| | | | | | | value |

What is claimed is:

1. An ink composition containing at least a chromatic pigment, polymer particles and water, and further containing hydrophobic silica fine particles.

2. The ink composition according to claim 1, wherein the volume ratio of the hydrophobic silica fine particles to the chromatic pigment is 1:20 to 2:1.

3. The ink composition according to claim 1, wherein the primary particle diameter of the hydrophobic silica fine particles is 20 nm or less.

4. The ink composition according to claim 1, wherein the chromatic pigment and the hydrophobic silica fine particles are contained in the polymer particles, and wherein the polymer particles are water-insoluble polymer particles.

5. The ink composition according to claim 1, wherein 50 ppm or less of silica is present in a dissolved state in liquid components of the ink.

6. The ink composition according to claim 1, further containing a penetration enhancer and/or humectant.

7. A recording method for printing on a recording medium by affixing an ink composition, wherein the ink composition according to any one of claims 1 through 6 is used as the ink composition.

8. An inkjet recording method for printing by discharging droplets of an ink composition and affixing the droplets to a recording medium, wherein the ink composition according to any one of claims 1 through 7 is used as the ink composition.
